(19) United States
(12) Patent Application Publication
(10) Pub. No.: US 2026/0158364 A1
(43) Pub. Date: Jun. 11, 2026

(54) GAME-COURT-SURFACE PROJECTOR

(71) Applicant: Shalinder Gupta, Metairie, LA (US)

(72) Inventor: Shalinder Gupta, Metairie, LA (US)

(21) Appl. No.: 19/462,820

(22) Filed: Jan. 28, 2026

Related U.S. Application Data
(63) Continuation-in-part of application No. 17/086,246, filed on Oct. 30, 2020.

(51) Int. Cl. A63C 19/06; A63B 71/06; H04N 9/31

(52) U.S. Cl. CPC A63C 19/065; A63B 71/0622; A63B 71/0669; H04N 9/3194; A63B 2071/0694; A63B 2225/74; A63B 2243/0037

(57) ABSTRACT

A game-court-surface projector system and method providing projection of a variety of projected images upon a game court or half court, showing proper boundaries and lines for various games and levels of play, allowing multiple uses for one game court or half court, allowing the development of new games or variants, and allowing improved training and practice by using accurate boundaries and lines for different games and levels of play, and using other projected images.

### CROSS-REFERENCE TO RELATED APPLICATION

This application is a continuation-in-part of co-pending application Ser. No. 17/086,246, filed on Oct. 30, 2020, the full disclosure of which is incorporated by reference herein and priority of which is hereby claimed.

### BACKGROUND

This invention provides a game-court-surface projector system and method providing projection of a variety of projected images including boundaries and lines upon a game court or half court.

Basketball and similar games are played officially on large courts with exact dimensions which vary depending upon the league or level of play. At private residences and at many schools and playgrounds, there is not sufficient clear space to maintain a full-sized court. Even where space the equivalent of a half court is used, such space is often required to be used for other sports or for other purposes. If boundaries and lines for a specific type and variant of a specific sport are painted onto the court or half court, those lines are not correct for use with other variants and other sports.

For example, in basketball the overall length of the court, and therefore the placement of the half-court line, is shorter for high school games than for professional and college games. The placement of free-throw and three-point lines is different among the levels of basketball. College basketball provides different lines for men's and for women's games.

If a player is training or practicing for eventual play upon a specific court, any improper placement of boundaries and lines on the practice court can interfere with the effectiveness of the training.

When a team sport is played by a single player or small number of players, it can be advantageous to modify boundaries and lines to adapt to the smaller number of players.

What is needed is a system and method of placing appropriate boundaries and lines upon a court for one use, with the ability to easily change them for another use.

US Patent Application Publication No. 2016/0246039 for an “Interactive Projection System,” published on Aug. 25, 2016 by applicant The Regents of the University of Michigan, discloses an interactive projection system for outputting illuminated indicia upon a projection surface. A detection system is operable to detect both stationary and movable features. A control system is operable to determine the position of the stationary and movable features. A reflective device reflects light from a light source (natural and/or artificial) upon the projection surface as the illuminated indicia. A drive system moves the reflective device, thereby moving the illuminated indicia across the projection surface in response to control system thereby simulating the stationary feature on the projection surface as a physical boundary to the illuminated indicia and simulating the movable feature contacting the illuminated indicia.

U.S. Pat. No. 8,690,715 for a “Light Source Projecting Lines Defining Activity Area,” issued on Apr. 8, 2014 to inventor Steven D. Vogt, provides for a lighting system, for use in combination with a basketball backboard device mounted on a pole, the system comprising a plurality of lighting devices positioned adjacent the basketball backboard device. The lighting devices comprise a housing, a connector, a first light source, a lens and a light filter, and a secondary light source. The lens focuses lines defined by the light filter. The first light source is positioned to project the lines on to an activity surface to define a foul lane for a basketball court. The connector connects the housing to the pole supporting the basketball backboard device. The secondary light source is positioned to simultaneously illuminate a backboard of the basketball backboard device while the first light source projects the lines through the lens and the light filter. The lines from the first light source combine together on the activity surface to define an area for a basketball game.

Korean Patent No. 10-1978325 for an “Apparatus for Displaying Sports Field Line and Net Using Laser,” issued on May 14, 2019 to applicants DONGSEO TECHNOLOGY HEADQUARTERS et al., provides for a stadium line and net display device using a laser. The device marks a boundary in forming a stadium, thereby eliminating discomfort caused by inhalation of powder, and removing the powder during a game. It is possible to eliminate disputes that may arise due to ambiguity, and because there is no need to install the net to raise or lower the position according to the type of game, the game can be performed quickly and easily. It can be easily modified so that it can be played at any time, so it can be used in a variety of places due to its high adaptability to the space, and its portability and installation is easy. It can be easily removed after the game is over, so that it can be used again as the original space. Through the user's mobile terminal, various sizes of stadiums can be accommodated. By determining the standard and forming a line of the stadium corresponding to the boundary of the stadium using a laser, the shape of the stadium is formed, and the net is formed through the laser transceiver included in the net pillar, and whether the line of the stadium and the net are in contact. By adding a warning light so that users of various age groups can play their favorite games, a new laser can be provided.

Korean Patent No. 10-1199421 for an “Apparatus for Displaying Sports Field Line,” issued on Nov. 9, 2012 to applicant Sungkyunkwan University, provides for a stadium line display device for displaying a stadium of various types and standards on the floor outdoors or indoors by irradiating a laser beam. The stadium line display device according to the present invention comprises a housing forming an appearance; a beam generator installed inside the housing and irradiating a laser beam to display a stadium of various types and specifications on an outdoor or indoor floor; and, it is formed on one side of the outer surface of the housing comprises a fixing portion detachably coupled to the external structure.

U.S. Pat. No. 10,653,936 for a “Free Kick Distance Projecting Device,” issued on May 19, 2020 to inventor Natalis Ganzer, provides for a display device for displaying a marking in the form of a distance to be kept between game equipment, in particular a football, and a participant on a playing field of a sports facility, and includes a display device for projecting light beams representing the marking onto the playing field. The projected light beams display the distance to be kept, and can be projected at least in sections in the shape of a circle, for example at a distance of 9.15 m, around the game equipment on the playing field. The display device is jointly movable with a transport device that is movable above the sports facility.

U.S. Pat. No. 8,979,273 for a “Line Display System Using Projector,” issued on Mar. 17, 2015 to assignee Seiko Epson Corporation, provides for a line display system capable of changing a line easily when the sporting event is changed, the line display system including plural projectors, each of which is installed to project a line image on a floor surface or a ground surface.

U.S. Pat. No. 5,342,041 for a “Guiding System for Athletes,” issued on Aug. 30, 1994 to inventors Aaron Agulnek et al., provides for an apparatus for assisting players during practices or in games, such as basketball, in which a ball or other object is directed toward a desired location. A video camera detects the ball and provides a signal indicating the location of the ball. A processor uses the location to determine an optimal location to direct the ball, and provides a signal to an illumination system. The illumination system provides a visual indication of where the player should direct the ball. The apparatus should be able to accommodate a game in which a ball may move quickly.

U.S. Pat. No. 5,684,453 for a “Basketball Training Apparatus,” issued on Nov. 4, 1997 to inventor Scott A. Welch, provides for an electronic basketball training apparatus that instructs a player to move to a sequence of zones and allows the player a limited amount of time to make a basket in each zone. The apparatus computes results and statistics which can be printed out or viewed from a computer screen. The invention can have the computer automatically communicate or allow a coach to communicate the next zone to the player. The invention uses a switch sensor in the basketball net to sense when a basket is made, laser beam sensors on the floor to locate the position of the player, a controller, memory, software, a visual display terminal, a printer, and a speaker to perform the training routine.

### SUMMARY OF THE INVENTION

This invention provides a game-court-surface projector providing projection of a variety of projected images upon a game court or half court, showing proper boundaries and lines for various games and levels of play. The game-court-surface projector allows multiple uses for one game court or half court, allows the development of new games or variants, and allows improved training and practice by using accurate boundaries and lines for different games and levels of play, and using other projected images.

A projector unit projects a projected image using light from a light supply unit, controlled by a control link and control unit. The game-court-surface projector provides projection of boundaries and lines for a variety of games, and projection of information display images virtual object images, movement marker images, and virtual layout images.

### BRIEF DESCRIPTION OF THE DRAWINGS

Reference will now be made to the drawings, wherein like parts are designated by like numerals, and wherein:

FIG. 1 is a schematic view of the game-court-surface projector of the invention in use;

FIG. 2 is a schematic view of the game-court-surface projector of the invention in use for a professional basketball court;

FIG. 3 is a schematic view of the game-court-surface projector of the invention in use for a college basketball court;

FIG. 4 is a schematic view of the game-court-surface projector of the invention in use for a high school basketball court;

FIG. 5 is a schematic view of the game-court-surface projector of the invention in use with an information display image;

FIG. 6 is a schematic view of the game-court-surface projector of the invention in use with virtual player images;

FIG. 7 is a schematic view of the game-court-surface projector of the invention in use with movement marker images;

FIG. 8 is a schematic view of two instances of the game-court-surface projector of the invention in use together through remote communications;

FIG. 9 is a schematic view of the game-court-surface projector of the invention in use with a virtual layout image;

FIG. 10 is a schematic view of the game-court-surface projector of the invention in use with an information display image showing a game-end countdown;

FIG. 11 is a schematic view of the game-court-surface projector of the invention in use with an information display image showing a shot clock; and

FIG. 12 is a schematic view of the game-court-surface projector of the invention in use with a virtual player image of a villain-monster.

### DETAILED DESCRIPTION OF THE INVENTION

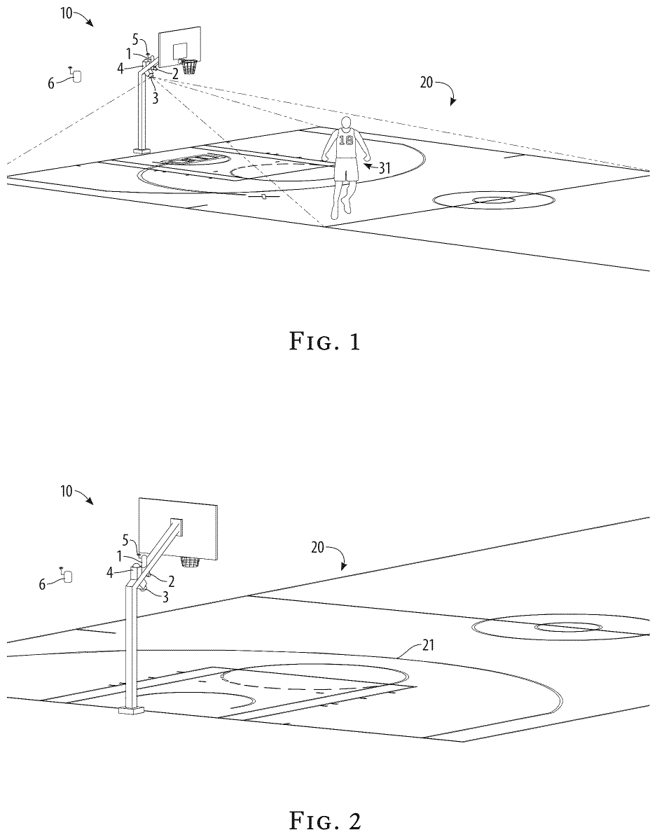

Referring to FIG. 1, the game-court-surface projector system 10 of the invention is shown in use projecting a projected image 20 on the surface of a game court such as a basketball court. A controller 1 controls the operation of the system. The controller 1 can be implemented as microcomputer, computer-on-a-chip, single-board computer, or similar electronic device or devices known in the art. The controller 1 provides a control link 5 which facilitates wireless communications with a remote unit 6, as treated below. The controller 1 can be mounted on a basketball backboard support, as shown, in close proximity to the image-capture unit 2 and projector unit 3, treated below, which can therefore be connected with short cables, and mounted in a position which will not interfere with wireless communications through the control link 5.

An image-capture unit 2 is provided to capture information in real time about the positions and the movements of persons and objects, such as a ball, on the projected image 20 on the court surface. The image-capture unit 2 can include one or more video-camera type units having a lens focusing an image on a sensor chip, as known in the art. The video information is analyzed by the controller using known image-processing techniques to determine in real time the position and the movement of persons such as the first player 31 shown, and determine the position and movement of a ball or other object. Using more than one such video-camera type unit, at known fixed distances each from the other, can provide depth-enhanced video information. Additional information about position and movement can also be provided from detectors and sensors such as LIDAR sensors, passive or active infrared sensors, ultrasonic rangefinder sensors, known in the art, incorporated into the image-capture unit 2. In circumstances where players are wearing uniform-type clothing having prominent identifying numbers, and where opposing players wear contrasting-colored uniforms, the controller 1 should be able to identify and track individual players from the video information. The image-capture unit 2 can be mounted on a basketball backboard support as shown, allowing for a clear view of the court surface.

The projected image 20 image is projected from a projector unit 3 suspended above the game court at an optimal place which is not obtrusive to the use of the court, such as the location on a basketball backboard support as shown. Light for the projected image is supplied by the light supply unit 4. The light supply unit 4 can supply light from an incorporated artificial light source, such as LED lighting known in the art, and also might gather incident ambient light such as sunlight, and focus, concentrate, and amplify that light sufficiently to project an image which is visible in that ambient light, using techniques known in the art.

The controller 1 provides a control link 5 and a remote unit 6 for controlling the projected image 20 and other operation of the system through the controller 1. The control link 5 provides wireless communication as known in the art, such as WIFI, BLUETOOTH, and other standard protocols. The remote unit 6 is a wireless hand-held remote-control unit. The remote unit 6 can be a purpose-built unit or the remote unit 6 function can be implemented on a smart device such as a smartphone, tablet, laptop computer, or other device having wireless communications capabilities.

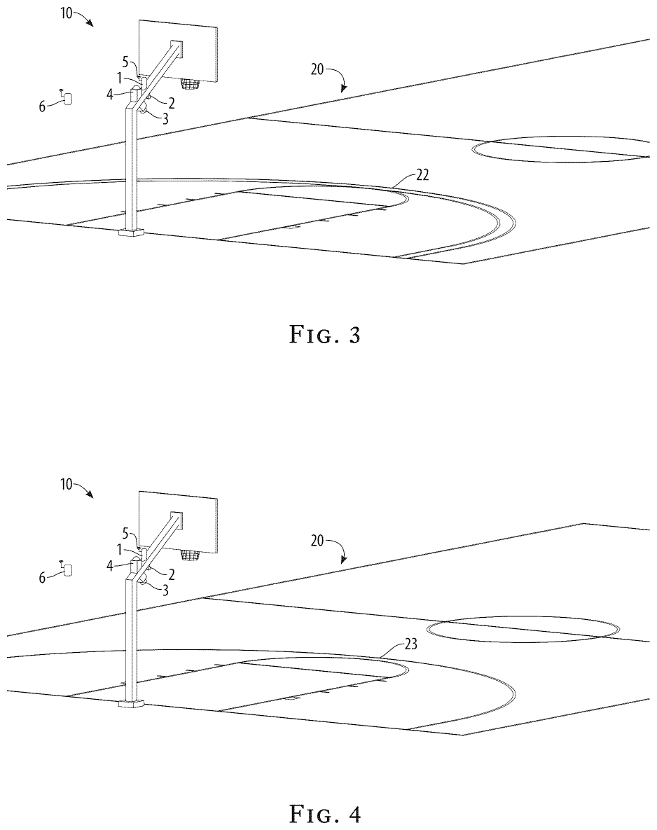

Referring to FIG. 2, FIG. 3, and FIG. 4, the game-court-surface projector 10 is shown in use projecting a professional basketball court image 21, a college basketball court image 22, and a high school basketball court image 23. The different levels of basketball use different court configurations with different distances and different placement of lines. The game-court-surface projector 10 projects the proper boundaries and lines for a given level of play, and can then be changed to project other boundaries and lines. Use on a half court is shown. Use on a full court would be best implemented with two projectors. It is anticipated that the game-court-surface projector 10 will be useful in half-court setups such as a residential driveway, a playground, training and practice facilities, and other circumstances where space is limited or where space must also be used for other games or purposes. The game-court-surface projector 10 facilitates the use of a game court or half court for a variety of games or other purposes because no lines or markers need to be painted permanently on the court, but can be projected as needed and quickly changed as needed. With the game-court-surface projector 10 a player or a team of players would be able to train or play on a court or half-court having the appropriate boundaries and lines for an accurate specific court configuration, and then the court could be put into a different configuration for different players or purposes.

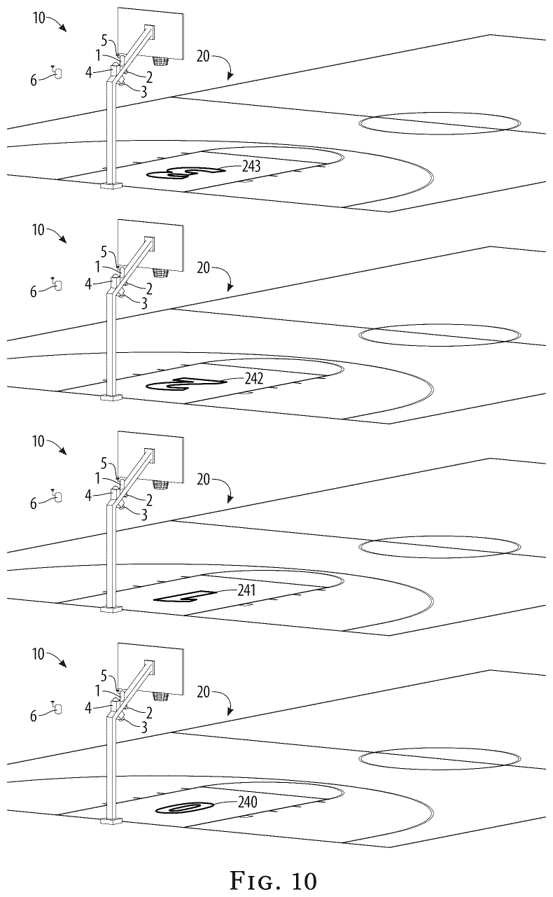

Referring to FIG. 5, the game-court-surface projector 10 can project an information display image 24 onto the court surface. As shown, the information display image 24 can be an indicator of time, such as time available to make a free throw or time elapsed or remaining. The information display image 24 can also be a score or the letters comprising “horse”. By displaying such information on the court itself both players and spectators can more easily see the information instead of having to look away from the court toward a scoreboard, or on a court not having a scoreboard, such as a driveway, playground, or practice court. The information displayed can be controlled through the remote unit 6 or automatically by the controller 1. Referring to FIG. 10, the information display image can be a countdown 243, 242, 241, 240 to the end of an exercise or a game. For the countdown the numerals can be made bigger or brighter, or can be made to flash, and can be coordinated with a buzzer or game-ending sound. Referring to FIG. 11, the information display image can be a shot clock 245 or similar timer displaying remaining time available for completing a shot or other action.

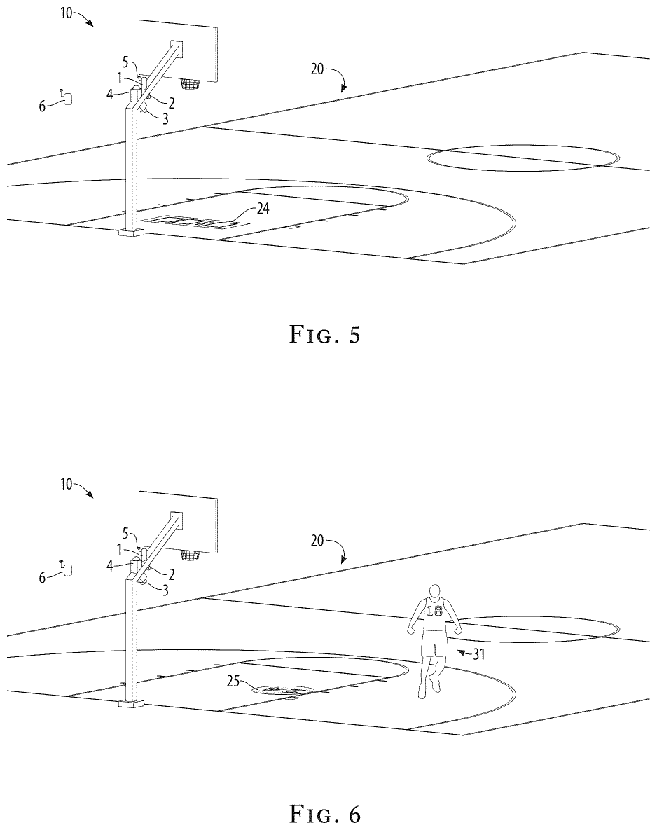

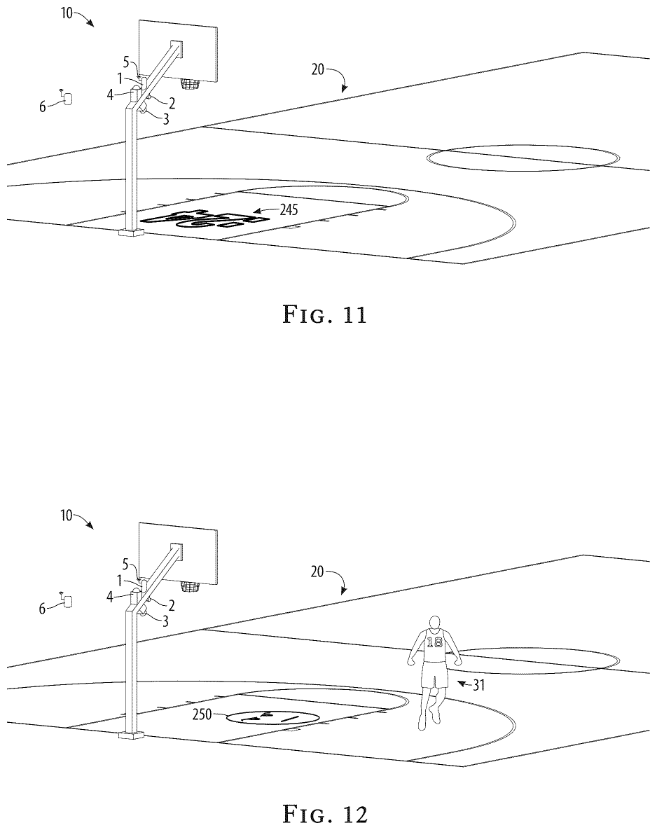

Referring to FIG. 6, the game-court-surface projector 10 can project one or more virtual object images 25 onto the court surface. The virtual object image 25 can represent an opposing player or an obstacle, and can be moved around on the court controlled in real time by an operator such as a coach through the remote unit 6, or controlled directly by the controller 1 as treated below. Virtual object images 25 can be used to simulate play for training purposes or to make play more challenging or interesting for a single player or small number of players. Referring to FIG. 12, the virtual object image can be a villain-monster 250 type of opponent which might engage the interest of young players and enhance the effectiveness of drills as well as games.

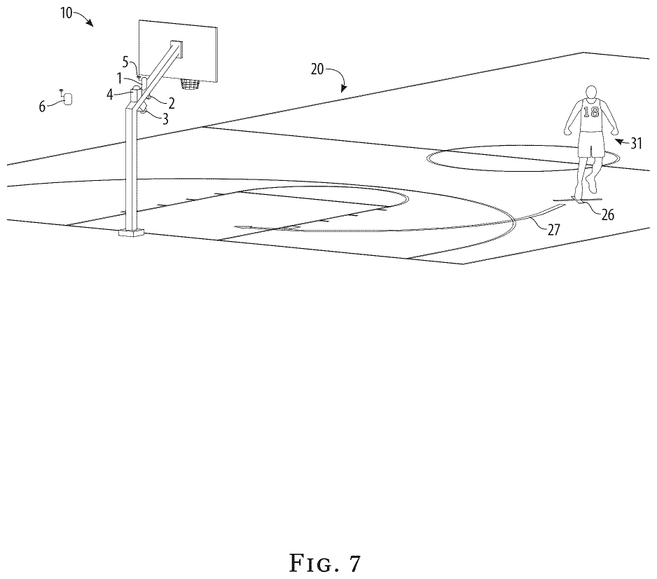

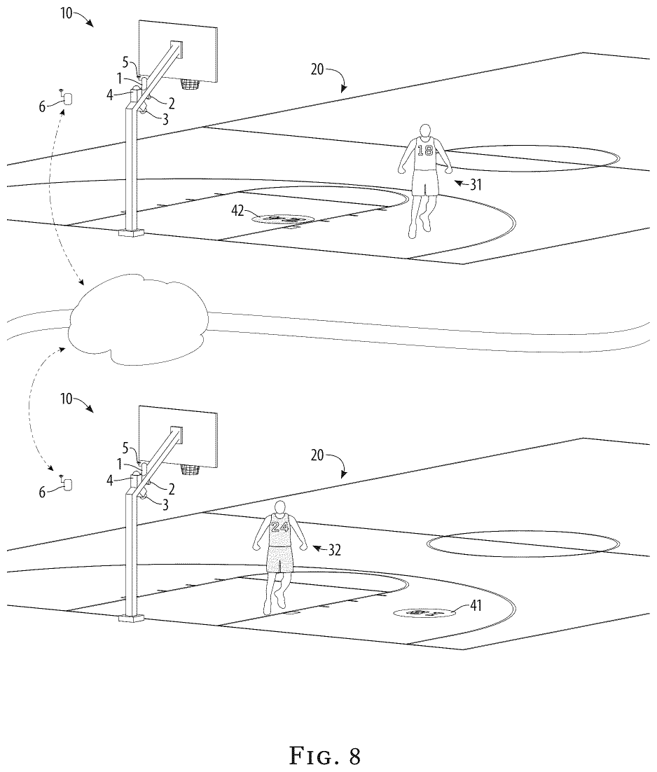

Referring to FIG. 7, the game-court-surface projector 10 can project one or more movement marker images 26, 27 onto the court surface. A movement marker image 26 might be used to indicate, for example, a spot from which a player is required to make a shot. Another movement marker image 27 might be used to indicate a path of movement to be taken. Placement of the movement marker images 26, 27 can be controlled in real time by an operator such as a coach through the remote unit 6, or controlled directly by the controller 1 as treated below, and can be use to, for example, provide a comprehensive drill or practice of different types of shots, or to invent games or variations of games.

As treated above, the controller 1 receives real-time information from the image-capture unit 2 which the controller 1 analyses to track the positions and movements of the player or players and of the ball. The controller 1 can also predict future positions and movements based on the recent tracking. Also, where the controller 1 knows the identity of the specific player, either by identifying the player through visual information and looking up earlier stored data, or by having the player's identity and profile input into the controller 1 through the remote unit 6, the controller 1 can incorporate such additional information into predictions of future movements. The controller 1 also controls the operation of the projector unit 3, including placement and movement of virtual object images 25 such as virtual opposing players and location marker images 26, 27 such as positions and paths. The controller 1 can, for example, move a virtual object image 25 representing an opposing player into the current path of a player, or display to the player a movement marker image 27 showing a path to approach for a shot. This can be done either autonomously by the controller 1 or can be instructed through the remote unit 6. Because the controller 1 can track the position and movement of the ball, the controller 1 can, for example, determine whether a ball has gone out of bounds, or whether a ball has been dribbled, carried, or passed directly over a virtual object image 25 representing a virtual opposing player, where the ball would have collided with a real opposing player and would have been deflected. Using the game-court-surface projector 10, specific drills, training, and practice routines can be programmed for specific players and circumstances.

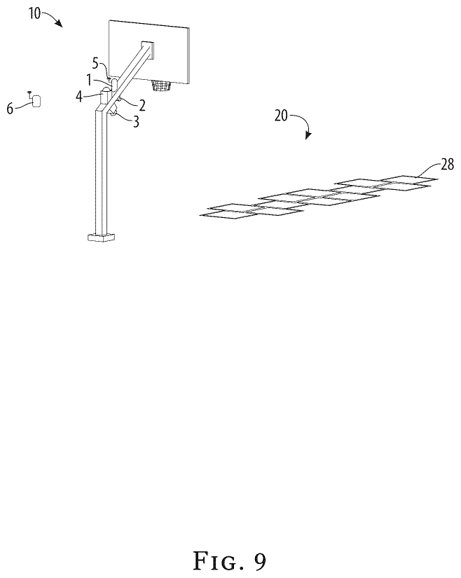

Referring to FIG. 8, because the controller 1, through the control link 5, can be controlled by a remote unit 6, which can be implemented on a smartphone, tablet, laptop computer, or similar device also having the capability of communicating over longer distances through the Internet, it is possible to use two instances of the game-court-surface projector system 10 in the manner shown. On a first projected image 20, a first player 31 is present in person. On a second projected image 20, in a separate location from the first, a second player 32 is present in person. The two systems are in communication over the Internet through their remote units 6. The positions and movements of the first player 31 are tracked by the first court's image-capture unit 2 and controller 1, and are transmitted to the second court, where the controller 1 causes the projector unit 3 to project a virtual object image 41 representing the position of the first player 31 onto the surface of the second court. Also, the positions and movements of the second player 32 on the second court are tracked and transmitted to the first court, and are projected as a virtual object image 42 representing the position of the second player 32 onto the surface of the second court. The game-court-surface projector 10 system can be used in this way with additional real and virtual players. The system can also be used in a similar way where only one projected court is used, but one or more of the coaches or observers are located remotely.

Referring to FIG. 9, the game-court-surface projector 10 can project a virtual layout image 28 onto the court surface. The virtual layout image 27 can represent a game of hopscotch, as shown, or can provide boundaries and lines for other games, including custom-made games and games having changing boundaries and lines, under the control of the remote unit 6. For example, games could be devised in which the boundaries and lines change according to the number of players participating or change with the passage of time.

Many other changes and modifications can be made in the system and method of the present invention without departing from the spirit thereof. I therefore pray that my rights to the present invention be limited only by the scope of the appended claims.

I claim:

1. A game-court-surface projector system comprising:
(i) a projector unit adapted to project a projected image upon a game court surface;
(ii) an image-capture unit adapted to capture position and movement information about persons and objects on the game court surface;
(iii) a controller having a control link, adapted to receive and track information from said image-capture unit and to control said projector unit;
(iv) a light supply unit adapted to supply light to said projector unit; and
(v) a remote unit adapted to communicate with said controller through said control link.

2. The game-court-surface projector system of claim 1, where said light supply unit further comprises adaptation to focus and concentrate incident ambient light.

3. The game-court-surface projector system of claim 1, where said light supply unit further comprises an artificial light source.

4. The game-court-surface projector system of claim 1, where said projected image further comprises a basketball court image.

5. The game-court-surface projector system of claim 1, where said projected image further comprises an information display image.

6. The game-court-surface projector system of claim 1, where said projected image further comprises a virtual object image.

7. The game-court-surface projector system of claim 1, where said projected image further comprises a movement marker image.

8. The game-court-surface projector system of claim 1, where said projected image further comprises a virtual layout image.

9. The game-court-surface projector system of claim 5, where said information display image further comprises an indication of time.

10. The game-court-surface projector system of claim 5, where said information display image further comprises score information.

11. The game-court-surface projector system of claim 6, where said virtual object image further comprises representation of an opposing player.

12. The game-court-surface projector system of claim 6, where said virtual object image further comprises representation of an obstacle.

13. The game-court-surface projector system of claim 7, where said movement marker image further comprises an indication of a location from which to make a shot.

14. The game-court-surface projector system of claim 8, where said virtual layout image further comprises boundaries and lines for a game.

15. The game-court-surface projector system of claim 1, where said projected image further comprises a changing image.

16. The game-court-surface projector system of claim 1, where said projected image further comprises changeable images corresponding to the number of participating players.

17. The game-court-surface projector system of claim 1, where said projected image further comprises changeable images corresponding to the passage of time.

18. The game-court-surface projector system of claim 1, where said remote unit is implemented on a smart device.

19. A game-court-surface projector system comprising:
(i) a projector unit adapted to project a projected image upon a game court surface;
(ii) an image-capture unit adapted to capture position and movement information about persons and objects on the game court surface;
(iii) a controller having a control link, adapted to receive and track information from said image-capture unit and to control said projector unit;
(iv) a light supply unit adapted to supply light to said projector unit; and
(v) a remote unit implemented on a smart device, adapted to communicate with said controller through said control link.

20. A game-court-surface projection method comprising:
(i) providing a game-court-surface projector comprising:
(a) a projector unit adapted to project a projected image upon a game court surface;
(b) an image-capture unit adapted to capture position and movement information about persons and objects on the game court surface;
(c) a controller having a control link, adapted to receive and track information from said image-capture unit and to control said projector unit;
(d) a light supply unit adapted to supply light to said projector unit; and
(e) a remote unit adapted to communicate with said controller through said control link; and
(ii) projecting a said projected image upon a game court surface under control of said controller and said remote unit.
